(19) United States
(12) Patent Application Publication
(10) Pub. No.: US 2019/0351636 A1
(43) Pub. Date: Nov. 21, 2019

(54) SHEET STACKING DEVICE, COUNTER EJECTOR, AND BOX MAKING MACHINE

(71) Applicant: MITSUBISHI HEAVY INDUSTRIES MACHINERY SYSTEMS, LTD., Hyogo (JP)

(72) Inventors: Kazuya AKITA, Hiroshima (JP); Makoto SHIMOHATSUBO, Hiroshima (JP); Koshi TANIMOTO, Tokyo (JP)

(21) Appl. No.: 16/478,974

(22) PCT Filed: Jan. 18, 2018
(86) PCT No.: PCT/JP2018/001411

§ 371 Date: Jul. 18, 2019

(30) Foreign Application Priority Data
Jan. 23, 2017 (JP) 2017-009444

(51) Int. Cl. B31B 50/98; B65H 31/10; B31B 50/00; B31B 50/04; B31B 50/88; B31B 50/62

(52) U.S. Cl. CPC B31B 50/98; B65H 31/10; B31B 50/624; B31B 50/042; B31B 50/88; B31B 50/006

(57) ABSTRACT

A sheet stacking device includes a hopper unit on which box making sheet material is stacked; an ejection unit that ejects the sheet material to the hopper unit; a first blowing device that is disposed above the downstream side of the hopper unit in the transfer direction of the sheet material and that presses the sheet material downward by blowing air; a pressing device that is disposed above an upstream side of the hopper unit in the transfer direction of the sheet material and that presses the sheet material downward; and a control device that controls an operation of the first blowing device pressing a front end of the sheet material downward, and controls an operation of the pressing device so as to press a rear end of the sheet material downward with a pressing force higher than that applied to the front end of the sheet material.

### RELATED APPLICATIONS

The present application is a National Phase of International Application Number PCT/JP2018/001411 filed Jan. 18, 2018 and claims priority to Japanese Application Number 2017-009444 filed Jan. 23, 2017.

### TECHNICAL FIELD

The present invention relates to a sheet stacking device that stacks manufactured flat corrugated boxes to form a stack, a counter ejector to which the sheet stacking device is applied and which collects and counts corrugated sheets to discharge the corrugated sheets in a batch, and a box making machine to which the counter ejector is applied.

### BACKGROUND ART

Typical box making machines process sheet materials (for example, corrugated sheets), thereby producing a box member (corrugated box), and are constituted of a sheet feed section, a printing section, a slotter creaser section, a die cutting section, a folder gluer section, and a counter ejector section. The sheet feed section ejects corrugated sheets stacked on a table one by one to send the corrugated sheets to the printing section at a constant speed. The printing section has a printing unit and performs printing on a corrugated sheet. The slotter creaser section forms creasing lines serving as folding lines on the corrugated sheet on which printing is performed, and processes grooves for forming flaps and gluing margin strips for joining. The die cutting section performs punching for hand holes on the corrugated sheet in which the creasing lines, the grooves, and the gluing margin strips are formed. The folder gluer section applies glue to the gluing margin strips, performs folding along the creasing lines, and joining the gluing margin strips while moving the corrugated sheet in which the creasing lines, the grooves, the gluing margin strips, and the hand holes are processed, thereby producing a flat corrugated box. The counter ejector section stacks corrugated boxes obtained by the corrugated sheets being folded and glued, and then sorts and discharges the corrugated boxes in a batch of a predetermined number of sheets.

The counter ejector section of such a box making machine is disposed at a most downstream part of the box making machine, collects, counts, and stacks the produced flat corrugated boxes to discharge the corrugated boxes in a batch of a predetermined number of sheets. This counter ejector section has a hopper unit on which corrugated boxes are stacked, stops the movement of a corrugated box, which is ejected above the hopper unit in a horizontal state by ejection rolls, in a transfer direction, and causes blowing devices, which are disposed on a front end and a rear end of the hopper unit, to blow air to the corrugated box to drop the corrugated box on the hopper unit and stack corrugated boxes by a predetermined number of sheets. As such a box making machine, for example, there is one described in the following PTLs.

### CITATION LIST

### Patent Literature

[PTL 1] Japanese Patent No. 5773666

[PTL 2] Japanese Unexamined Patent Application Publication No. 05-208774

### SUMMARY OF INVENTION

### Technical Problem

In recent years, in such a box making machine, speeding-up has progressed. However, if the production rate is increased, the behavior of a corrugated box becomes unstable and it becomes difficult to stack the corrugated boxes in order on the hopper unit in a correct posture. In above-described PTL 1, the blowing devices are disposed on the front end and the rear end of the hopper unit and blow air to the corrugated box, which is ejected above the hopper unit in a horizontal state by ejection rolls, to drop the corrugated box to the hopper unit. However, since the air is constantly blown to the corrugated box to be ejected above the hopper unit, in a case where ejection rolls eject a lightweight and large-sized corrugated box which does not have sufficient rigidity to the position above the hopper unit in a horizontal state, a distal end of the corrugated box is inclined downward, and the corrugated box is broken and damaged. Further, in PTL 2, a flexible cam is brought into contact with a supplied sheet and presses the sheet in the stack direction. However, in order to rotationally drive the flexible cam in synchronization with a movement of the sheet and press a rear end of the sheet in a transfer direction downward, it is necessary to provide drive means for rotationally driving the flexible cam. However, the drive means makes the device complicated and causes costs increase.

The present invention is to solve the above-described problems, and an object thereof is to provide a sheet stacking device, a counter ejector, and a box making machine capable of inhibiting an occurrence of damage to box making sheet material with respect to high-speed transfer of the box making sheet material and appropriately stacking the box making sheet material in a predetermined posture.

### Solution to Problem

According to achieve the above object, the present invention provides a sheet stacking device. The sheet stacking device includes a hopper unit on which box making sheet material is stacked, a ejection unit that ejects the box making sheet material to the hopper unit, a first blowing device that is disposed above the downstream side of the hopper unit in a transfer direction of the box making sheet material and that presses the box making sheet material downward by blowing air, a pressing device that is disposed above an upstream side of the hopper unit in the transfer direction of the box making sheet material and that presses the box making sheet material downward, and a control device that controls an operation of the first blowing device pressing a front end of the box making sheet material downward, and controls an operation of the pressing device so as to press a rear end of the box making sheet material downward with a pressing force higher than that applied to the front end of the box making sheet material.

Therefore, when the box making sheet material is ejected above the hopper unit by the ejection units, the front end of the box making sheet material is pressed downward by the air blown from the first blowing device and the rear end of the box making sheet material is pressed downward by the pressing device. At this time, the pressing device presses the rear end of the box making sheet material downward with a pressing force higher than that applied to the front end of the box making sheet material, thereby forward downward inclination of the front end of the box making sheet material is inhibited. The box making sheet material can avoid the collision with the box making sheet material stacked on the hopper unit to inhibit damage, and the stacking can be appropriately performed while maintaining the horizontal state. As a result, an occurrence of damage to the box making sheet material with respect to high-speed transfer of the box making sheet material can be inhibited, and the box making sheet material can be appropriately stacked in a predetermined posture.

In the sheet stacking device of the present invention, the control device controls the operation of the pressing device so as to press only the rear end of the box making sheet material downward.

Accordingly, since only the rear end of the box making sheet material ejected above the hopper unit is pressed downward by the pressing device, a forward-lean posture of the box making sheet material is inhibited by pressing the front end downward. Therefore, the box making sheet material can be appropriately stacked while maintaining the horizontal state.

In the sheet stacking device of the present invention, the pressing device is a second blowing device pressing the box making sheet material downward by blowing air.

Accordingly, since the rear end of the box making sheet material ejected above the hopper unit is pressed downward by the air blown from the second blowing device, a forward-lean posture of the box making sheet material is inhibited by pressing the front end downward. Therefore, the box making sheet material can be appropriately stacked while maintaining the horizontal state. Moreover, since the box making sheet material is pressed by blown air, there is no member in direct contact with the box making sheet material, and damage to the box making sheet material can be inhibited.

In the sheet stacking device of the present invention, the control device stops an operation of the second blowing device while the front end of the box making sheet material is transferred below the second blowing device.

Therefore, since the operation of the second blowing device is stopped while the front end of the box making sheet material is transferred below the second blowing device, the air blown from the second blowing device does not press the front end downward and the box making sheet material can be inhibited from being in the forward-lean posture.

In the sheet stacking device of the present invention, the control device stops the operation of the second blowing device while the front end of the box making sheet material enters above the hopper unit.

Therefore, since the operation of the second blowing device is stopped while the front end of the box making sheet material enters above the hopper unit, the air blown from the second blowing device does not press the front end downward and the box making sheet material can be inhibited from being in the forward-lean posture.

In the sheet stacking device of the present invention, the control device starts the operation of the second blowing device after the rear end of the box making sheet material passes the ejection unit.

Therefore, since the operation of the second blowing device starts after the rear end of the box making sheet material passes the ejection unit, the rear end of the box making sheet material ejected above the hopper unit is pressed downward by blown air; therefore, the box making sheet material can be appropriately stacked.

In the sheet stacking device of the present invention, a position sensor detecting a transfer position of the box making sheet material is provided, and the control device controls the operation of the second blowing device based on a detecting result of the position sensor.

Therefore, since the operation of the second blowing device is controlled based on the transfer position of the box making sheet material detected by the position sensor, the posture of the box making sheet material is stabilized by precisely controlling the air blowing and stopping of the blowing device.

In the sheet stacking device of the present invention, the control device sets a pressing force of the second blowing device against the box making sheet material higher than a pressing force of the first blowing device against the box making sheet material.

Accordingly, the front end of the box making sheet material ejected above of the hopper unit is pressed down by the air blown from the first blowing device, and the rear end is pressed down by the air blown from the second blowing device. In that case, since the rear end is pressed down by the stronger air, the box making sheet material can be inhibited from being in the forward-lean posture.

In the sheet stacking device of the present invention, the second blowing device includes a plurality of blowing ports which are aligned along the transfer direction of the box making sheet material and a plurality of damper mechanisms which open and close the plurality of blowing ports, and the control device sequentially opens the plurality of damper mechanisms from the upstream side in the transfer direction of the box making sheet material.

Therefore, when the box making sheet material is ejected above the hopper unit, the control device controls the plurality of damper mechanisms to blow air from the upstream side in the transfer direction of the box making sheet material, that is, from the rear end toward the intermediate part of the box making sheet material; therefore, the box making sheet material can be appropriately stacked while maintaining the horizontal state.

The sheet stacking device of the present invention, the second blowing device includes a rotary roller capable of rotating about a rotation axis along a horizontal direction intersecting the transfer direction of the box making sheet material, and a blowing port disposed on an outer peripheral portion of the rotary roller along a rotation axis direction.

Therefore, when the box making sheet material is ejected above the hopper unit by the ejection unit, the blowing port of the rotary roller faces the rear end of the box making sheet material and air is blown from the blowing port to the rear end of the box making sheet material, thereby forward downward inclination of the front end of the box making sheet material is inhibited. The box making sheet material can avoid the collision with the box making sheet material stacked on the hopper unit to inhibit damage, and the stacking can be appropriately performed while maintaining the horizontal state.

In the sheet stacking device of the present invention, the pressing device is a cam device including a cam member capable of rotating about a rotation axis along a horizontal direction intersecting the transfer direction of the box making sheet material.

Therefore, when the box making sheet material is ejected above the hopper unit by the ejection unit, the rotating cam member presses the rear end of the box making sheet material, thereby forward downward inclination of the front end of the box making sheet material is inhibited. The box making sheet material can avoid the collision with the box making sheet material stacked on the hopper unit to inhibit damage, and the stacking can be appropriately performed while maintaining the horizontal state.

Additionally, a counter ejector of the present invention includes the sheet stacking device, and the box making sheet materials are sorted in a batch of a predetermined number of sheets and are discharged after being stacked while being counted.

Accordingly, in the sheet stacking device, the pressing device does not press the front end of the box making sheet material downward with a high pressing force, thereby forward downward inclination of the front end of the box making sheet material is inhibited. The box making sheet material can avoid the collision with the box making sheet material stacked on the hopper unit to inhibit damage, and the stacking can be appropriately performed while maintaining the horizontal state. As a result, the occurrence of damage to the box making sheet material with respect to high-speed transfer of the box making sheet material can be inhibited, and the box making sheet material can be appropriately stacked in a predetermined posture.

Additionally, a box making machine of the present invention includes a sheet feed section that supplies a box making sheet material; a printing section that performs printing on the box making sheet material; a slotter creaser section that performs creasing on a front surface of the box making sheet material and performs grooving; a folder gluer section that folds the box making sheet material to join ends together, thereby forming a box member; and a counter ejector section that discharges every predetermined number of the box members after being stacked while being counted. The above counter ejector is applied as the counter ejector section.

Therefore, printing is performed on the box making sheet material supplied from the sheet feed section by the printing section, creasing and grooving are performed by the slotter creaser section, folding is performed by the folder gluer section to join ends together to form the box member, and the box member is stacked while being counted by the counter ejector section. Accordingly, in the counter ejector section, the pressing device does not press the front end of the box making sheet material downward with a high pressing force, thereby forward downward inclination of the front end of the box making sheet material is inhibited. The box making sheet material can avoid the collision with the box making sheet material stacked on the hopper unit to inhibit damage, and the stacking can be appropriately performed while maintaining the horizontal state. As a result, the occurrence of damage to the box making sheet material with respect to high-speed transfer of the box making sheet material can be inhibited, and the box making sheet material can be appropriately stacked in a predetermined posture.

### Advantageous Effects of Invention

According to the sheet stacking device of the present invention, the counter ejector, and the box making machine of the present invention, the operation of the first blowing device is controlled so as to press the front end of the box making sheet material downward, and the operation of the pressing device is controlled so as to press the rear end of the box making sheet material downward with a higher pressing force than that applied to the front end. Therefore, it is possible to inhibit the occurrence of damage to box making sheet material with respect to high-speed transfer of the box making sheet material and appropriately stacking the box making sheet material in a predetermined posture.

### BRIEF DESCRIPTION OF DRAWINGS

FIG. 1 is a schematic configuration view illustrating a box making machine of a first embodiment.

FIG. 2 is a schematic configuration view illustrating a counter ejector of the first embodiment.

FIG. 3 is a schematic view illustrating a sheet stacking device of the first embodiment.

FIG. 4 is a schematic view illustrating an operation of the sheet stacking device.

FIG. 5 is a schematic view illustrating the operation of the sheet stacking device.

FIG. 6 is a schematic view illustrating the operation of the sheet stacking device.

FIG. 7 is a schematic view illustrating the operation of the sheet stacking device.

FIG. 8 is a schematic view illustrating a second fan.

FIG. 9 is a schematic view illustrating a modification example of the second fan.

FIG. 10 is a schematic view illustrating a damper mechanism.

FIG. 11 is a schematic view illustrating a first modification example of the damper mechanism.

FIG. 12 is a schematic view illustrating a second modification example of the damper mechanism.

FIG. 13A is a schematic view illustrating a third modification example of the damper mechanism.

FIG. 13B is a schematic view illustrating an operation of the damper mechanism according to the third modification example.

FIG. 14 is a schematic view illustrating a sheet stacking device of a second embodiment.

FIG. 15 is a schematic view illustrating an operation of the sheet stacking device.

FIG. 16 is a schematic view illustrating a cam device.

FIG. 17 is a schematic view illustrating a first modification example of the cam device.

FIG. 18 is a schematic view illustrating a second modification example of the cam device.

FIG. 19 is a front view of a cam roller.

FIG. 20 is a front view of another cam roller.

FIG. 21 is a schematic view illustrating a sheet stacking device of a third embodiment.

FIG. 22 is a sectional view of a rotary roller.

FIG. 23 is a schematic view illustrating a sheet stacking device of a fourth embodiment.

### DESCRIPTION OF EMBODIMENTS

Preferred embodiments of a sheet stacking device, a counter ejector, a box making machine related to the present invention will be described below in detail with reference to the accompanying drawings. In addition, the present invention is not limited to the embodiments and includes those configured by combining respective embodiments in a case where there are a plurality of embodiments.

### First Embodiment

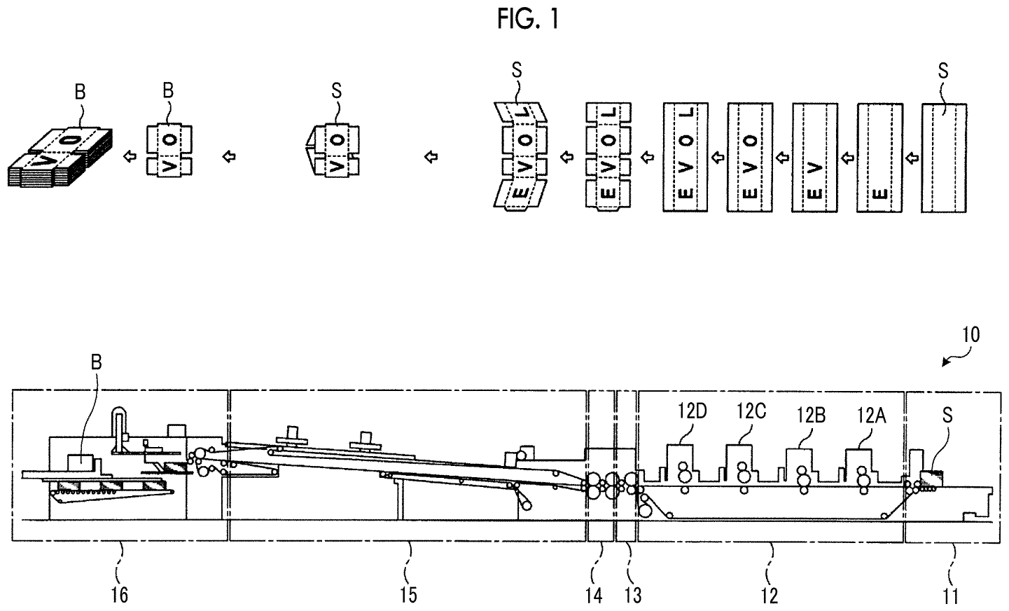

First, a box making machine of the first embodiment will be described. FIG. 1 is a schematic configuration view illustrating the box making machine of the first embodiment.

In the first embodiment, as illustrated in FIG. 1, a box making machine 10 produces a corrugated box B by processing a corrugated sheet S. The box making machine 10 is constituted of a sheet feed section 11, a printing section 12, a slotter creaser section 13, a die cutting section 14, a folder gluer section 15, and a counter ejector section 16 that are linearly disposed in a direction in which the corrugated sheet S and the corrugated box B are transferred.

In the sheet feed section 11, a number of plate-shaped corrugated sheets S are carried in a stacked state, and the corrugated sheets S are ejected one by one and are sent to the printing section 12 at a constant speed. The printing section 12 performs multi-colored printing (four-color printing in the first embodiment) on a front surface of each corrugated sheet S. The printing section 12 has four printing units 12A, 12B, 12C, and 12D disposed in series, and is capable of performing printing on the front surface of the corrugated sheet S using four ink colors. The slotter creaser section 13 performs creasing and performs grooving on the corrugated sheet S.

The die cutting section 14 performs punching for hand holes on the corrugated sheet S. The folder gluer section 15 folds the corrugated sheet S while moving the corrugated sheet S in a transfer direction, and joins both ends thereof in a width direction to form a flat corrugated box B. The counter ejector section 16 stacks corrugated boxes B manufactured by the folder gluer section 15 while counting the corrugated boxes B, and then sorts and discharges the corrugated boxes B in a batch of a predetermined number of sheets.

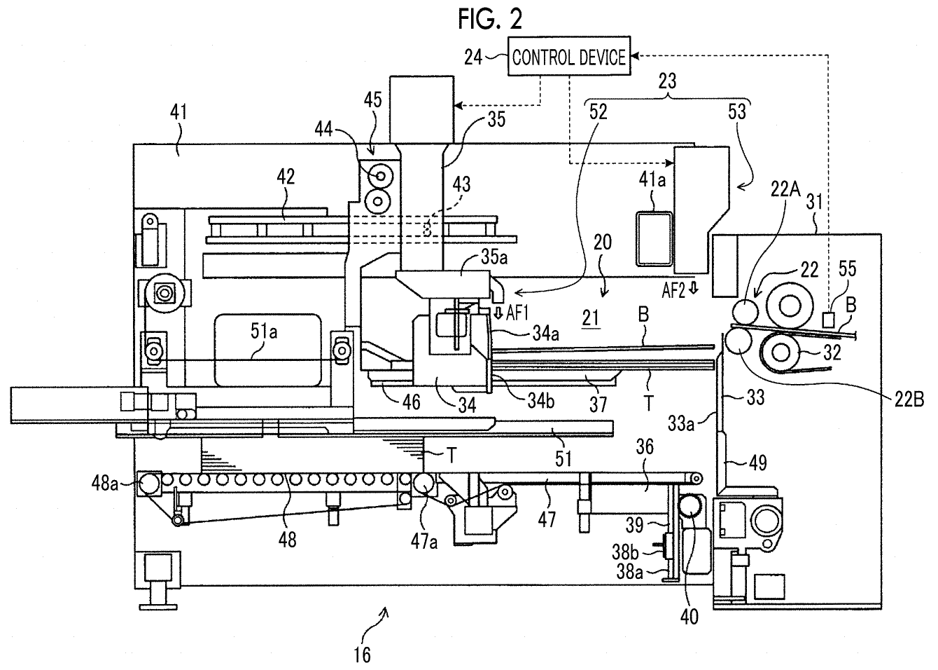

Next, the counter ejector section 16 of the first embodiment will be described in detail. FIG. 2 is a schematic configuration view illustrating the counter ejector of the first embodiment.

As illustrated in FIG. 2, the counter ejector section (counter ejector) 16 of the first embodiment has a sheet stacking device 20 of the first embodiment. The sheet stacking device 20 includes a hopper unit 21 for stacking flat corrugated boxes B (box making sheet material), a ejection rolls (ejection unit) 22 for ejecting the corrugated box B to the hopper unit 21, a blowing device 23 for pressing the corrugated box B downward to be transferred on the hopper unit 21, and a control device 24 for controlling operation of the blowing device 23.

Frames 31 are respectively erected on both sides, in a machine width direction, of an inlet part of the counter ejector section 16, and an outlet conveyor roller 32 of the folder gluer section 15 (see FIG. 1) and a pair of upper and lower ejection rolls 22 are attached to the frames 31. The ejection roll 22 has an upper ejection roll 22A and a lower ejection roll 22B having a rotation axis in the horizontal direction orthogonal to the transfer direction of the corrugated box B, and eject the horizontally interposed corrugated box B to a transfer passage along the horizontal direction.

In the frames 31, a rear part of each ejection roll 22 is provided with a spanker 33 that presses a rear end of a stack (in which a plurality of corrugated boxes B are stacked) T. The spanker 33 is provided with an abutting surface 33a against which a rear end of the corrugated box B abuts, and a part below an intermediate part of the abutting surface 33a is provided in a vertical direction. However, an upper end of an upper part of the abutting surface 33a is inclined so as to shift to an upstream side in the transfer direction of the corrugated box B.

In the hopper unit 21, space where the stack T is formed as corrugated boxes B are stacked is provided below an outlet side of the ejection rolls 22, and this space serves as the hopper unit 21. The ejection rolls 22 eject the corrugated box B toward an upper space of the hopper unit 21.

The hopper unit 21 face a downstream side in the transfer direction of the corrugated box B, and a flexible front stopper 34, which stops the corrugated box B discharged from the folder gluer section 15 while decelerating the corrugated box B, is supported so as to be movable in a forward-backward direction. That is, the front stopper 34 is provided so as to be movable in the forward-backward direction by a motor (not illustrated) with respect to a supporting part 35a of a ledge support 35. The front stopper 34 has a flexible stop plate 34a formed of a flexible material, and is capable of stopping the movement of the corrugated box B in the transfer direction while decelerating the corrugated box B and being elastically deformed itself if a front end of the corrugated box B abuts thereagainst. However, a high-rigidity stop plate 34b formed of, for example, a high-rigidity material, such as metal, is provided at a lower part of the flexible stop plate 34a, and the flexible stop plate 34a is capable of restricting the movement of the stack T at a front edge of the stack T as a rear end of the stack T is pressed by the spanker 33.

An elevator 36 is provided below the hopper unit 21, and the stack T collected from a ledge 37 to the middle is delivered to the hopper unit 21, and the hopper unit 21 receives corrugated box B that hit the front stopper 34 and fell on the stack T, and collects the corrugated boxes B to form the stack T of a predetermined number of sheets. The elevator 36 is disposed horizontally below a portion slightly in front of the ejection rolls 22, is supported by a supporting shaft 39 provided with a rack 38a, and is configured so as to be reciprocable in an upward-downward direction by a driving mechanism consisting of the rack 38a, a pinion 38b to mesh with the rack 38a, and a servo motor 40 combined with the pinion 38b.

Side frames 41 are respectively provided on both sides in the machine width direction on the downstream side of the hopper unit 21 in the transfer direction of the corrugated box B in the counter ejector section 16, rails 42 are horizontally provided in the side frames 41, and the ledge support 35 is supported by the rails 42 on both sides so as be capable of traveling. That is, the ledge support 35 is provided with a roller 43 that travels on each rail 42, a pinion (not illustrated) that meshes with a rack (not illustrated) provided along the rail 42, and a ledge back-and-forth servo motor 44 that rotationally drives this pinion. For that reason, the ledge support 35 can be moved in the forward-backward direction by driving the ledge back-and-forth servo motor 44 to normally and reversely rotating ledge back-and-forth servo motor 44.

The ledge support 35 is provided with the ledge 37 that horizontally extends via a lifting mechanism 45. Although not illustrated, the lifting mechanism 45 is constituted of a rack-and-pinion mechanism, a ledge lifting servo motor that rotationally drives this pinion, and the like, and the ledge support 35 is capable of being lifted and lowered by the normal and reverse rotation of the servo motor.

The ledge 37 receives corrugated box B that abutted against the front stopper 34 and fell therefrom, and collects the corrugated boxes B to form the stack T. The stack T is delivered to the elevator 36 while being formed. Thereafter, if corrugated boxes B are further collected on the elevator 36 and the stack T reaches a set number of sheets, the elevator 36 is replaced to receive corrugated box B in order to operate again and to form the following stack T.

A press bar 46 that presses the stack T is supported on the ledge 37 so as to be capable of being lifted and lowered by a lifting mechanism (not illustrated). This lifting mechanism is also constituted of a rack-and-pinion mechanism (not illustrated), and a press bar lifting servo motor (not illustrated) that rotationally drives this pinion, and the press bar 46 is capable of being lifted and lowered by the normal and reverse rotation of the servo motor.

That is, a lower conveyor 47 is provided at the same height level as an upper surface of the elevator 36 when the elevator 36 has moved downward to the maximum, and a discharge conveyor 48 is further provided at a height position at the same level as the lower conveyor 47 downstream of the lower conveyor. The lower conveyor 47 and the discharge conveyor 48 are respectively driven by a servo motor 47a for the lower conveyor, and a servo motor 48a for the discharge conveyor. The lower conveyor 47 is installed to enter the back of the elevator 36 so that an inlet tip position is located sufficiently close to a pusher 49 so as to be capable of receiving even a corrugated box B of a minimum length (transfer direction length is a minimum).

Moreover, an upper conveyor 51, which pinches the stack T together with the lower conveyor 47 and the discharge conveyor 48, is supported above the lower conveyor 47 and the discharge conveyor 48 such that the position thereof in a height direction is capable of being adjusted via a moving mechanism 51a. Additionally, the upper conveyor 51 is movable also in the forward-backward direction, and is configured so as to move up to a certain distance from the front stopper 34 in conjunction with the front stopper 34 in accordance with the corrugated box B.

Fans 52 and 53, constituting the blowing device 23 which blow air AF1, AF2 downward from above against an upper surface of the corrugated box B ejected from the ejection rolls 22, are provided above the elevator 36 (namely, above the hopper unit 21). A first fan (first blowing device) 52 is disposed at the upper side of the hopper unit 21 on the downstream side in the transfer direction of the corrugated box B, and presses the corrugated box B downward by the air (blowing) AF1. The first fan 52 is a movable fan that is fixed to the supporting part 35a which supports the front stopper 34 and that moves in the forward-backward direction with the front stopper 34. A second fan (second blowing device, pressing device) 53 is disposed at the upper side of the hopper unit 21 on the upstream side in the transfer direction of the corrugated box B, and presses the corrugated box B downward by the air (blowing) AF2. The second fan 53 is a fixed fan fixed to a beam 41a supported by both side frames 41.

In the first embodiment, although the first fan 52 is disposed above a height level of an outlet of the ejection rolls 22 near an upper end of the front stopper 34, the first fan 52 is disposed relatively near the ejection rolls 22. On the other hand, the second fan 53 is disposed above the height level of the outlet of the ejection rolls 22 near each upper end of both side frames 41, and is largely separated from the ejection rolls 22.

Meanwhile, since the first fan 52 on the downstream side in the transfer direction approach the corrugated box B, strong wind can be partially applied to the front end of the corrugated box B, and the first fan 52 can be effectively used in a case where total air volume is insufficient only with the second fan 53. Moreover, since the first fan 52 is fixed to the front stopper 34 side, the first fan is adjusted such that wind is automatically blown against the front end of the corrugated box B in accordance with sheet length. Then, the first and second fans 52 and 53 can vertically blow air AF1 and AF2 from the upper side to the lower side, that is, can blow air AF1 and AF2 in a direction substantially orthogonal to the upper surface of the corrugated box B to be ejected from the ejection rolls 22 in a horizontal direction.

Further, the second fan 53 constituting the blowing device 23 can be operationally controlled by the control device 24. That is, a position sensor 55 for detecting a transfer position of the corrugated box B is provided on an upstream side of the outlet conveyor roller 32 of the folder gluer section 15 (see FIG. 1), and the control device 24 controls an operation of the second fan 53 based on the detecting result of the position sensor 55.

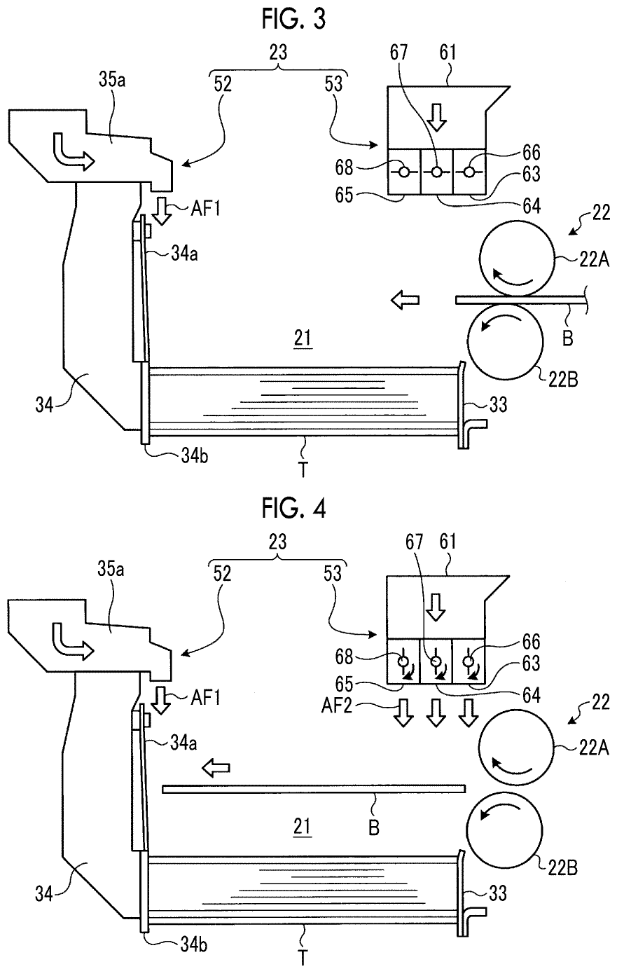

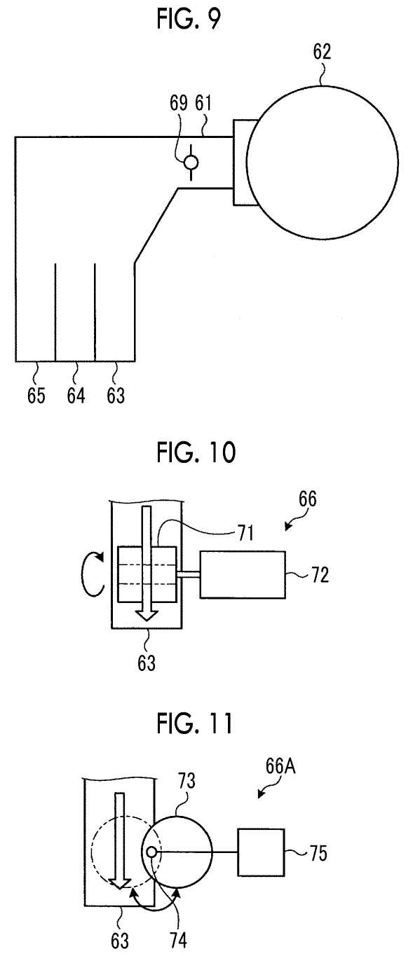

First, the second fan 53 constituting the blowing device 23 will be described in detail. FIG. 3 is a schematic view illustrating a sheet stacking device of the first embodiment. FIG. 8 is a schematic view illustrating the second fan, and FIG. 9 is a schematic view illustrating a modification example of the second fan.

As illustrated in FIGS. 3 and 8, the second fan 53 has a blower 62 connected to a base end of a duct 61, and the blower 62 can suck outside air and take the air into the duct 61. The duct 61 is bent downward in the vertical direction from the horizontal direction, and a plurality of (three in the first embodiment) blowing ports 63, 64, and 65 are provided at a distal end which is a lower side in the vertical direction. The respective blowing ports 63, 64 and 65 have a slit shape along a width direction of the corrugated box B (horizontal direction orthogonal to the transfer direction of the corrugated box B), and are provided along the transfer direction of the corrugated box B. Each blowing port 63, 64, and 65 is provided with damper mechanisms 66, 67, and 68, respectively. The damper mechanisms 66, 67, and 68 can open and close blowing ports 63, 64, and 65.

In the above description, although three blowing ports 63, 64, and 65 are provided at the distal end of the duct 61, and the damper mechanisms 66, 67, and 68 are provided in the blowing ports 63, 64, and 65, the configuration is not limited thereto. For example, as illustrated in FIG. 9, three blowing ports 63, 64, and 65 may be provided at the distal end of the duct 61, and one damper mechanism 69 may be provided at a horizontal part (or a vertical part) of the duct 61 on the upstream side of each blowing port 63, 64, and 65.

Next, the damper mechanisms 66, 67, 68, and 69 of the second fan 53 will be described in detail. FIG. 10 is a schematic view illustrating the damper mechanism.

As illustrated in FIG. 10, the damper mechanism 66 is constituted of a partition valve 71 having a shape matched to the passage shape of the blowing port 63, and a drive device (motor) 72 for rotating the partition valve 71. Therefore, when the partition valve 71 is rotated by the drive device 72 to a position facing an opening direction (air flow direction) of the blowing port 63, the partition valve 71 can stop air blown from the blowing port 63 as indicated by a two-dot chain line in FIG. 10, and when the partition valve 71 is rotated to a position along the opening direction of the blowing port 63, air can be blown out from the blowing port 63 as indicated by a solid line in FIG. 10.

The configuration of the damper mechanism 66 is not limited to the above-described configuration. FIG. 11 is a schematic view illustrating a first modification example of the damper mechanism. As illustrated in FIG. 11, a damper mechanism 66A is constituted of a partition valve 73 having a spherical shape matched to the passage shape of the blowing port 63, and a drive device (motor) 75 connected to the partition valve 73 via an eccentric shaft 74 to rotate the partition valve 73. Therefore, when the partition valve 73 is rotated by the drive device 75 to the blowing port 63, the partition valve 73 can stop air blown from the blowing port 63 as indicated by a two-dot chain line in FIG. 11, and when the partition valve 73 is rotated to outside of the blowing port 63, air can be blown out from the blowing port 63 as indicated by a solid line in FIG. 11. In this case, the partition valve 73 may be formed in a disc shape and configured to rotate in a direction intersecting the opening direction (air flow direction) of the blowing port 63.

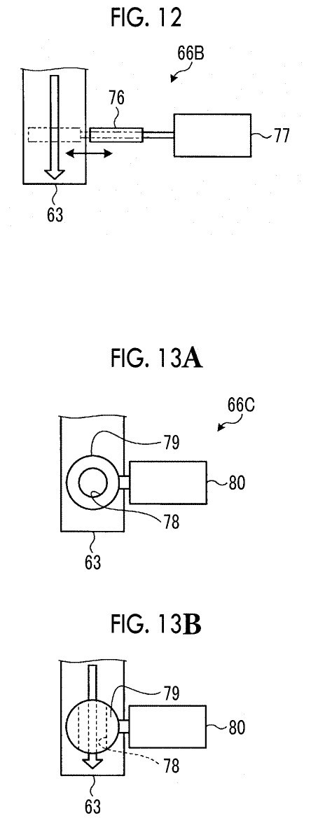

FIG. 12 is a schematic view illustrating a second modification example of the damper mechanism. As illustrated in FIG. 12, a damper mechanism 66B is constituted of a partition valve 76 having a disc shape matched to the passage shape of the blowing port 63, and a drive device (air cylinder) 77 for rotating the partition valve 76 in a reciprocating manner. Therefore, when the partition valve 76 is moved by the drive device 77 to the blowing port 63, the partition valve 76 can stop air blown from the blowing port 63 as indicated by a two-dot chain line in FIG. 12, and when the partition valve 76 is moved to outside of the blowing port 63, air can be blown out from the blowing port 63 as indicated by a solid line in FIG. 12.

FIG. 13A is a schematic view illustrating a third modification example of the damper mechanism, and FIG. 13B is a schematic view illustrating an operation of the opening and closing damper mechanism according to the third modification example. A damper mechanism 66C is constituted of a partition valve 79 having a spherical shape matched to the passage shape of the blowing port 63 and provided with a through-hole 78, and a drive device (motor) 80 for rotating the partition valve 79. Therefore, when the partition valve 79 is rotated by the drive device 80 such that the through-hole 78 is located to a position intersecting the opening direction (air flow direction) of the blowing port 63, the partition valve 79 can stop air blown from the blowing port 63, and when the partition valve 79 is rotated such that the through-hole 78 is located to a position along the opening direction (air flow direction) of the blowing port 63, air can be blown out from the blowing port 63 as illustrated in FIG. 13B.

In the blowing device 23 configured as described above, as illustrated in FIGS. 2 and 3, the control device 24 controls the operation of the first fan 52 so as to press the front end of the corrugated box B downward, and controls the operation of the second fan 53 so as to press the rear end of the corrugated box B downward with a pressing force higher than that of the front end of the corrugated box B.

Specifically, the control device 24 controls the operation of the second fan 53 so as to press only the rear end of the corrugated box B downward. That is, the control device 24 stops the operation of the second fan 53 while the front end of the corrugated box B is transferred above the hopper unit 21. That is, when the front end of the corrugated box B enters the upper side of the hopper unit 21, the control device 24 stops the operation of the second fan 53, and after the rear end of the corrugated box B passes the ejection rolls 22, and the control device 24 starts the operation of the second fan 53.

Further, the control device 24 sets the pressing force of the second fan 53 against the corrugated box B higher than the pressing force of the first fan 52 against the corrugated box B. Here, in a case where the control device 24 controls the operation of the second fan 53, the drive device may continuously rotate a partition plate in the same direction, and control a rotational speed to open the blowing port at a predetermined position and to close the blowing port at another predetermined position.

Here, the operation of the sheet stacking device 20 of the first embodiment will be described. FIGS. 4 to 7 are schematic views illustrating the operation of the sheet stacking device.

As illustrated in FIG. 3, the corrugated box B is transferred by the ejection rolls 22, and is stacked on the hopper unit 21. At this time, as illustrated in FIG. 4, air is blown downward from the fans 52 and 53 to the front end and the rear end of the corrugated box B, as represented by air AF1 and AF2 indicated by white arrows, thus biasing a fall of the corrugated box B.

To be more specific, the corrugated box B is ejected to the upper space of the hopper unit 21 in the horizontal direction by the ejection rolls 22. When the front end portion of the corrugated box B enters above of the hopper unit 21, the blowing port 63, 64, and 65 of the second fan 53 are closed by the damper mechanisms 66, 67, and 68. Therefore, the air AF2 is not blown from the second fan 53 to the front end of the corrugated box B, and the corrugated box B is ejected while maintaining a horizontal state without being in a forward-lean posture. At this time, in a case where the second fan 53 is operating, when the front end of the corrugated box B is ejected to an upper space of the hopper unit 21, air is blown from the blowing ports 63, 64, and 65 to the front end of the corrugated box B to drop the corrugated box B in a forward-lean posture, and the corrugated box B is dropped into the hopper unit 21 while maintaining the posture. Thus, the front end of the corrugated box B comes into contact with a high-rigidity stop plate 34b instead of flexible stop plate 34a of the front stopper 34. The distal end of the corrugated box B is bent, and is not able to be appropriately stacked on the hopper unit 21.

As illustrated in FIG. 4, when the front end of the corrugated box B approaches the flexible stop plate 34a of the front stopper 34 and the rear end of the corrugated box B comes to a position facing downward of the second fan 53, the damper mechanisms 66, 67, and 68 opens the blowing ports 63, 64, and 65 of the second fan 53. Therefore, the air is blown from the second fan 53 to the rear end of the corrugated box B to press the corrugated box B downward.

In this case, it is preferable that the damper mechanisms 66, 67, and 68 start to operate in the opening direction when an intermediate part of the corrugated box B comes to a position facing downward of the second fan 53 while taking account of a transfer speed of the corrugated box B and a speed of air blown from the second fan 53. Further, it is desirable that the second fan 53 has three blowing ports 63, 64, and 65 aligned in the transfer direction of the corrugated box B, and the damper mechanism 66, 67, and 68 sequentially opens the blowing ports 63, 64, and 65 from the upstream side in the transfer direction of the corrugated box B. Furthermore, in a case where the damper mechanisms 66, 67, and 68 are configured as shown in FIGS. 13A and 13B, in FIG. 4, it is desirable to rotate the partition valve clockwise to open the blowing ports 63, 64, and 65. Then, air is blown to the rear end of the corrugated box B, and a shift to the forward-lean posture is inhibited.

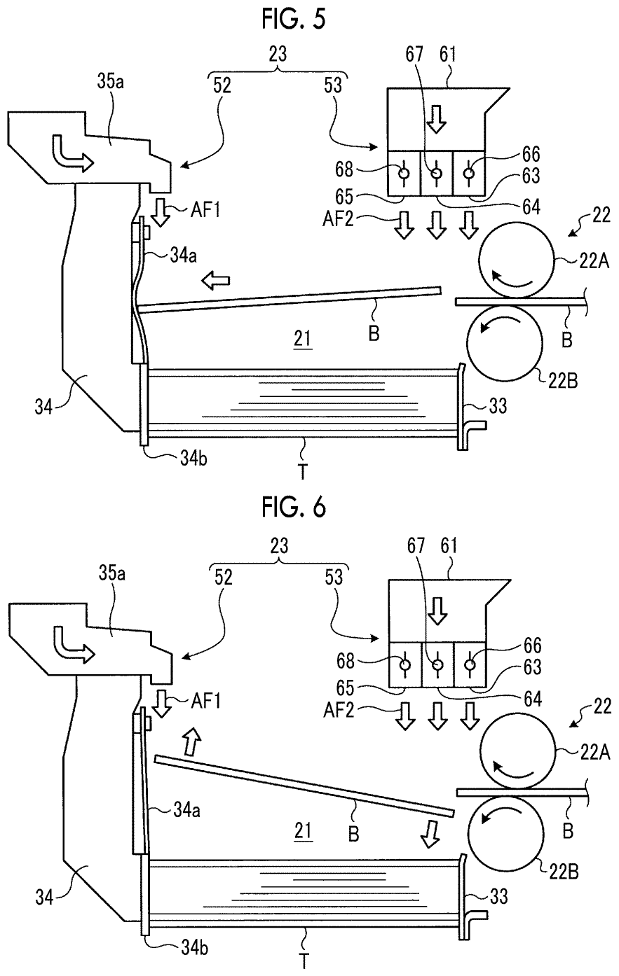

As illustrated in FIG. 5, the corrugated box B ejected to the upper space of the hopper unit 21 advances in a substantially horizontal posture, and the front end abuts against the flexible stop plate 34a of the front stopper 34. As the advancing corrugated box B abuts against the flexible stop plate 34a of the front stopper 34, the flexible stop plate 34a flexes and absorbs kinetic energy of the corrugated box B to decelerate movement of the corrugated box B.

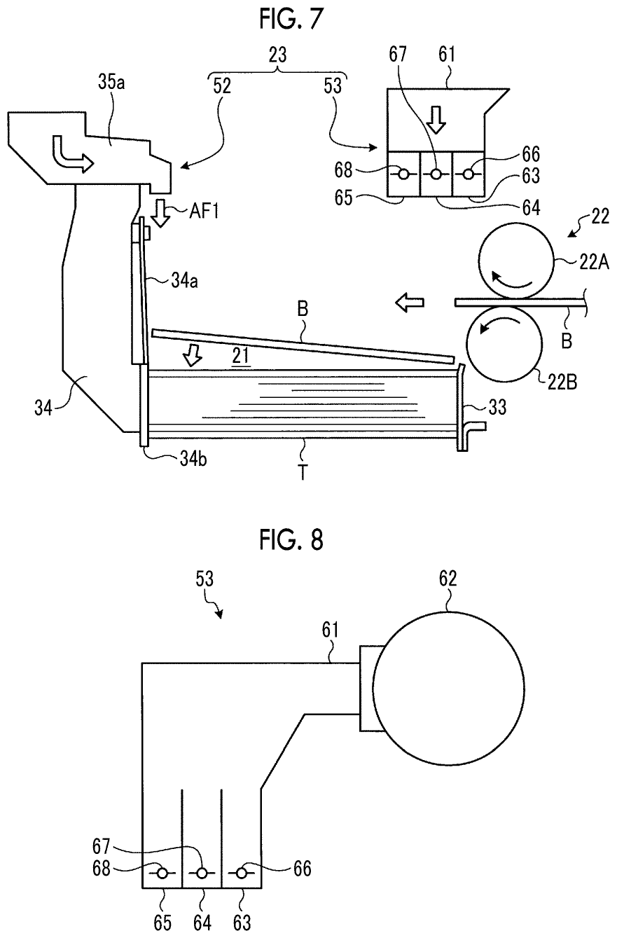

However, since the flexible stop plate 34a cannot absorb all the kinetic energy of the corrugated box B, as illustrated in FIG. 6, after the front end of the corrugated box B abuts against the front stopper 34, the corrugated box B falls while being moved backward by the reaction. At this time, the front end of the corrugated box B is pressed downward by the air AF1 blown from the first fan 52, and the rear end is pressed downward by the air AF2 blown from the second fan 53. Here, the pressing force of the second fan 53 against the corrugated box B is set to be higher than the pressing force of the first fan 52 against the corrugated box B. Therefore, the corrugated box B falls to the hopper unit 21 in a slightly backward-lean posture. That is, as illustrated in FIG. 7, the corrugated box B falls in the slightly backward-lean posture, and while the rear end comes into contact with the spanker 33 to be positioned, the corrugated box B is appropriately stacked maintaining an approximately horizontal posture. The predetermined number of stacks T are stacked to form a batch and the batch is discharged.

As described above, the sheet stacking device according to the first embodiment is provided with the hopper unit 21 stacking the flat corrugated boxes B, the ejection rolls 22 ejecting the corrugated box B to the hopper unit 21, the first fan 52 disposed above the downstream side of the hopper unit 21 in the transfer direction of the corrugated box B and pressing the corrugated box B downward with the air AF1, the second fan 53 disposed above the upstream side of the hopper unit 21 in the transfer direction of the corrugated box B and pressing the corrugated box B downward with the air AF2, and the control device 24 controlling the operation of the first fan 52 so as to press the front end of the corrugated box B downward and controlling the operation of the second fan 53 so as to press the rear end of the corrugated box B downward with the higher pressing force than that applied to the front end of the corrugated box B.

Therefore, as the corrugated box B is ejected by the ejection rolls 22, the front end of the corrugated box B is pressed downward by the air AF1 blown from the first fan 52, and the rear end is pressed downward by the air AF2 blown from the second fan 53. At this time, the second fan 53 presses the rear end of the corrugated box B downward with a pressing force higher than that applied to the front end of the corrugated box B, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state. As a result, an occurrence of damage to the corrugated box B with respect to high-speed transfer of the corrugated box B can be inhibited, and the corrugated box B can be appropriately stacked in a predetermined posture.

In the sheet stacking device according to the first embodiment, the control device 24 controls the operation of the second fan 53 so as to press only the rear end of the corrugated box B downward. Accordingly, the air AF2 is applied only to the rear end of the corrugated box B ejected above the hopper unit 21 so as to press the corrugated box B downward; thus, a forward-lean posture of the corrugated box B is inhibited by pressing the front end downward. Therefore, the corrugated box B can be appropriately stacked while maintaining the horizontal state.

In the sheet stacking device according to the first embodiment, the second fan 53 presses the corrugated box B downward by the air AF2, as in the first fan 52. Accordingly, the air is blown to the front end and the rear end of the corrugated box B ejected above the hopper unit 21, and a forward-lean posture of the corrugated box B is inhibited by pressing the front end downward. Therefore, the corrugated box B can be appropriately stacked while maintaining the horizontal state. Moreover, since the corrugated box B is pressed by air, there is no member that directly comes into contact with the corrugated box B, and damage to the corrugated box B can be inhibited.

In the sheet stacking device of the first embodiment, the control device 24 stops the operation of the second fan 53 while the front end of the corrugated box B is transferred below the second fan 53. Therefore, the front end of the corrugated box B is not pressed downward by the air AF2 blown from the second fan 53, and the corrugated box B can be inhibited from being in the forward-lean posture.

In the sheet stacking device of the first embodiment, the control device 24 stops the operation of the second fan 53 while the front end of the corrugated box B enters above the hopper unit 21. Therefore, when the front end of the corrugated box B enters above the hopper unit 21, the front end is not pressed downward by the air AF2 blown from the second fan 53, and the corrugated box B can be inhibited from being in the forward-lean posture.

In the sheet stacking device of the first embodiment, the control device 24 starts the operation of the second fan 53 after the rear end of the corrugated box B passes the ejection rolls 22. Therefore, after the corrugated box B passes the ejection rolls 22, the air AF2 is blown to the rear end of the corrugated box B to press the corrugated box B downward, so that the corrugated box B can be appropriately stacked.

The sheet stacking device of the first embodiment is provided with the position sensor 55 for detecting the transfer position of the corrugated box B, and the control device 24 controls the operation of the second fan 53 based on the detection result of the position sensor 55. Therefore, since the operation of the second fan 53 is controlled based on the transfer position of the corrugated box B detected by the position sensor 55, the posture of the corrugated box B is stabilized by precisely controlling the blowing and stopping of the air AF2.

Further, in the sheet stacking device according to the first embodiment, the control device 24 sets the pressing force of the second fan 53 against the corrugated box B higher than the pressing force of the first fan 52 against the corrugated box B. Accordingly, the front end of the corrugated box B ejected above the hopper unit 21 is pressed down by the air AF1 blown from the first fan 52, and the rear end is pressed down by the air AF2 blown from the second fan 53. In that case, since the rear end is pressed down by the stronger air AF2, the corrugated box B can be inhibited from being in the forward-lean posture.

In the sheet stacking device according to the first embodiment, the second fan 53 includes a plurality of blowing ports 63, 64, and 65 which are aligned along the transfer direction of the corrugated box B, and a plurality of damper mechanisms 66, 67, and 68 which opens and closes the plurality of blowing ports 63, 64, and 65. The control device 24 sequentially opens the plurality of damper mechanisms 66, 67, and 68 from upstream side in the transfer direction of the corrugated box B. Therefore, the air AF2 is sequentially applied from the rear end toward the intermediate part of the corrugated box B, and the corrugated box B can be appropriately stacked while maintaining the horizontal state.

Additionally, the counter ejector of the first embodiment is provided with the sheet stacking device 20. Accordingly, in the sheet stacking device 20, the second fan 53 does not press the front end of the corrugated box B downward with a high pressing force, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state. As a result, the occurrence of damage to the corrugated box B with respect to high-speed transfer of the corrugated box B can be inhibited, and the corrugated box B can be appropriately stacked in a predetermined posture.

Additionally, the box making machine of the first embodiment is provided with the sheet feed section 11, the printing section 12, the slotter creaser section 13, the die cutting section 14, the folder gluer section 15, and the counter ejector section 16, and the counter ejector section 16 is provided with the sheet stacking device 20. Therefore, printing is performed on the corrugated sheet S from the sheet feed section 11 by the printing section 12, creasing and grooving are performed by the slotter creaser section 13, folding is performed by the folder gluer section 15 to join ends together to form the corrugated box B, and the corrugated box B is stacked while being counted by the counter ejector section 16. Accordingly, in counter ejector section 16, the second fan 53 does not press the front end of the corrugated box B downward with a high pressing force, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state. As a result, the occurrence of damage to the corrugated box B with respect to high-speed transfer of the corrugated box B can be inhibited, and the corrugated box B can be appropriately stacked in a predetermined posture.

In the first embodiment described above, when the front end of the corrugated box B enters the upper side of the hopper unit 21, the operation of the second fan 53 is stopped, and when the rear end of the corrugated box B passes the ejection rolls 22, the operation of the second fan 53 is started, but the configuration is not limited thereto. For example, when the front end of the corrugated box B enters the upper side of the hopper unit 21, air blowing rate is reduced without stopping the operation of the second fan 53, and when the rear end of the corrugated box B passes the ejection rolls 22, the air blowing rate by the second fan 53 may be increased to increase the volume. That is, the second fan 53 may press the rear end downward with a pressing force higher than that applied to the front end portion of the corrugated box B.

### Second Embodiment

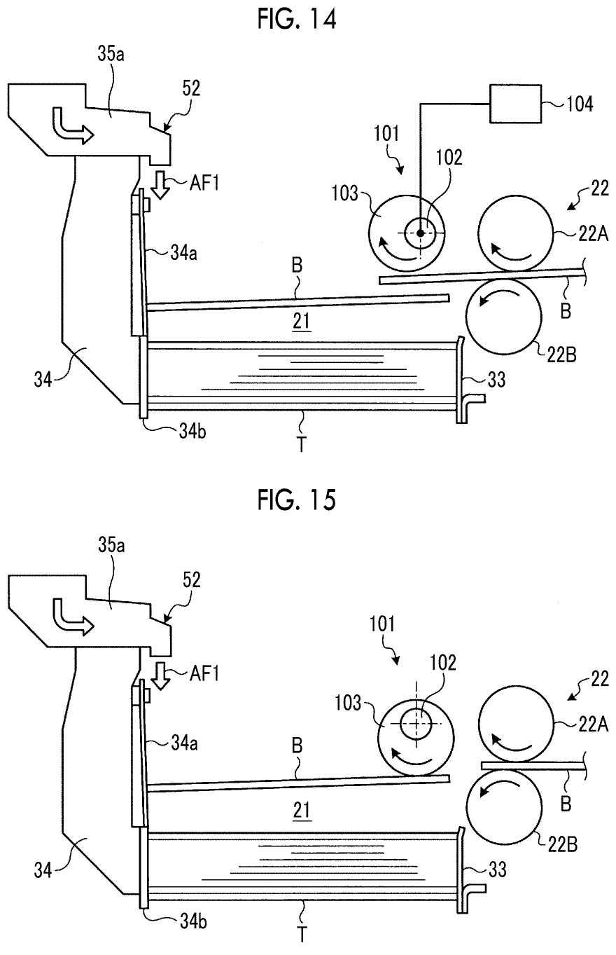

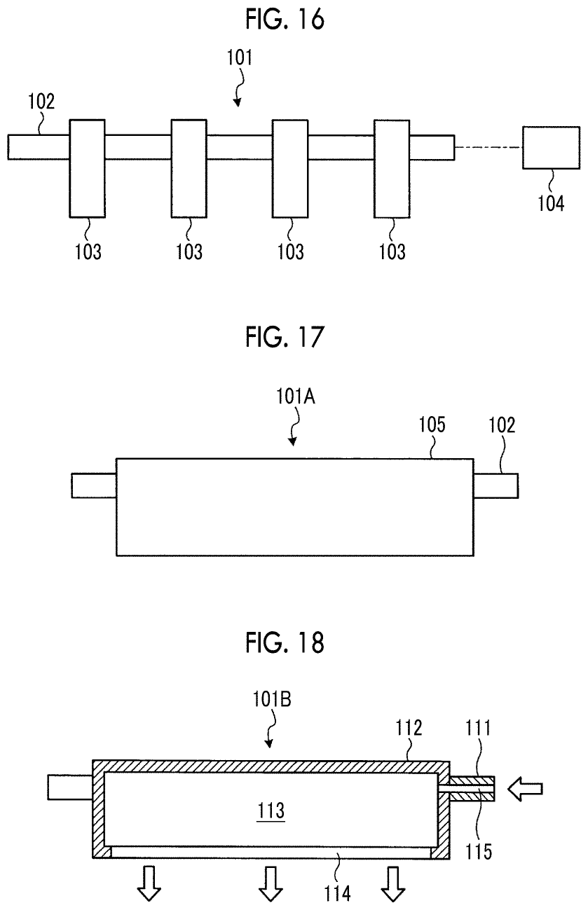

FIG. 14 is a schematic view illustrating a sheet stacking device of the second embodiment. FIG. 15 is a schematic view illustrating an operation of the sheet stacking device. FIG. 16 is a schematic view illustrating a cam mechanism. The members having the same functions as those in the above-described embodiment are denoted by the same reference numerals, and detailed descriptions thereof will be omitted.

The sheet stacking device according to the second embodiment, as illustrated in FIG. 14, includes the hopper unit 21, the ejection rolls (ejection unit) 22, the first fan 52, and a cam device (pressing device) 101.

As shown in FIGS. 14 and 15, the cam device 101 is disposed above the upstream side of the hopper unit 21 in the transfer direction of the corrugated box B and presses the corrugated box B downward using the cam mechanism. The cam device 101 includes a rotating shaft 102, a cam member 103, and a drive device 104. The rotating shaft 102 is disposed along a horizontal direction intersecting the transfer direction of the corrugated box B, each end in an axial direction is rotatably supported by a frame (not illustrated), and the rotating shaft 102 can be rotationally driven by the drive device (motor) 104. As illustrated in FIG. 16, a plurality of cam members 103 are fixed to the rotating shaft 102 at predetermined intervals in the rotation axis direction. The cam member 103 has a disk shape and is fixed at a position eccentric to the rotating shaft 102. That is, the rotation center of the rotating shaft 102 and the rotation center of the cam member 103 are shifted in the radial direction.

Therefore, when the rotating shaft 102 is rotated by the drive device 104, each cam member 103 is eccentrically rotated, so that when the corrugated box B is ejected to an upper space of the hopper unit 21, the rear end of the corrugated box B can be pressed downward. That is, the control device (not illustrated) drives and controls the drive device 104 so that when the corrugated box B is ejected to the upper space of the hopper unit 21, the rotational speed of the rotating shaft 102 is adjusted to make each cam member 103 pressing the rear end of the corrugated box B downward.

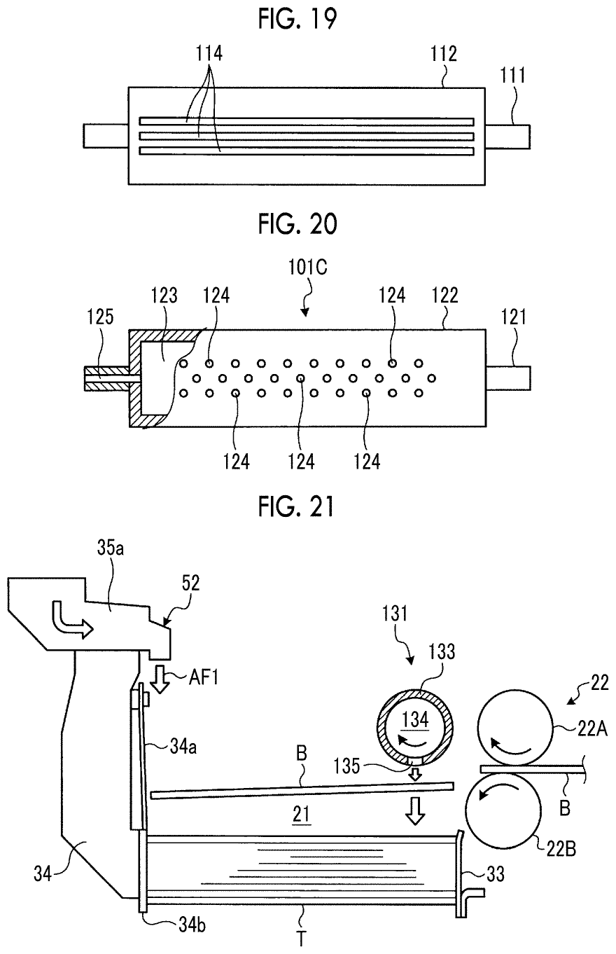

The configuration of the cam device 101 is not limited to the above-described configuration. FIG. 17 is a schematic view illustrating a first modification example of the cam mechanism. FIG. 18 is a schematic view illustrating a second modification example of the cam mechanism. FIG. 19 is a front view of a cam roller. FIG. 20 is a front view of another cam roller.

As illustrated in FIG. 17, a cam device 101A includes a rotating shaft 102 and a cam roller (cam member) 105. The cam roller 105 is fixed to the rotating shaft 102. The cam roller 105 has a cylindrical shape and is fixed at a position eccentric to the rotating shaft 102. That is, the rotation center of the rotating shaft 102 and the rotation center of the cam roller 105 are shifted in the radial direction. Therefore, when the rotating shaft 102 is rotated by the drive device, each cam roller 105 is eccentrically rotated, so that when the corrugated box B is ejected to the upper space of the hopper unit 21, the rear end of the corrugated box B can be pressed downward.

As illustrated in FIGS. 18 and 19, a cam device 101B includes a rotating shaft 111 and a cam roller (cam member) 112. The cam roller 112 is fixed to the rotating shaft 111. The cam roller 112 has a cylindrical hollow shape and is fixed at a position eccentric to the rotating shaft 111. A hollow portion 113 is formed in the cam roller 112, and a plurality of (three in the present embodiment) slits (blowing ports) 114 along the axial direction are formed on an outer peripheral portion at predetermined intervals in a circumferential direction. The rotating shaft 111 is formed with a flow path 115 for supplying air to the hollow portion 113 from outside.

Therefore, when the rotating shaft 111 is rotated by the drive device, each cam roller 112 is eccentrically rotated, so that when the corrugated box B is ejected to the upper space of the hopper unit 21, the rear end of the corrugated box B is pressed downward. At this time, air is blown to the hollow portion 113 through the flow path 115 and blown out from the slits 114. When the eccentrically rotating cam roller 112 is about to press the rear end of the corrugated box B downward, the air blown from each of the slits 114 presses the rear end of the corrugated box B, and the cam roller 112 does not directly press the rear end of the corrugated box B, thereby preventing contact between the cam roller 112 and the corrugated box B and preventing Damage to the corrugated box B.

As illustrated in FIG. 20, a cam device 101C includes a rotating shaft 121 and a cam roller (cam member) 122. The cam roller 122 is fixed to the rotating shaft 121. The cam roller 122 has a cylindrical hollow shape and is fixed at a position eccentric to the rotating shaft 121. The cam roller 122 is formed with a hollow portion 123, and a plurality of openings 124 are formed in a predetermined region in the circumferential direction on the outer peripheral portion. The rotating shaft 121 is formed with a flow path 125 for supplying air to the hollow portion 123 from outside. The operation of the cam device 101C is substantially the same as the operation of the cam device 101B, so the description thereof is omitted.

Here, the operation of the sheet stacking device of the second embodiment will be described. As illustrated in FIG. 14, the corrugated box B is transferred by the ejection rolls 22, and is stacked on the hopper unit 21. At this time, the air AF1 blown from the first fan 52 and the cam member 103 of the cam device 101 press the corrugated box B downward to cause the corrugated box B to fall.

To be more specific, the corrugated box B is ejected to the upper space of the hopper unit 21 in the horizontal direction by the ejection rolls 22. When the front end of the corrugated box B enters above the hopper unit 21, the cam member 103 is positioned above the corrugated box B and does not press the front end of the corrugated box B. At this time, in a case where the cam member 103 fall, when the front end of the corrugated box B is ejected to an upper space of the hopper unit 21, the front end of the corrugated box B falls by being pressed by the cam member 103 and is in a forward-lean posture, and the corrugated box B is dropped into the hopper unit 21 while maintaining the posture. Thus, the front end of the corrugated box B comes into contact with a high-rigidity stop plate 34b instead of flexible stop plate 34a of the front stopper 34. The distal end of the corrugated box B is bent, and is not able to be appropriately stacked on the hopper unit 21.

Then, as illustrated in FIG. 15, when the front end of the corrugated box B approaches the flexible stop plate 34a of the front stopper 34, and the rear end of the corrugated box B comes to a position facing the lower side of the cam member 103, the cam member 103 falls and the rear end of the corrugated box B is pressed down by the cam member 103, and the front end abuts against the flexible stop plate 34a of the front stopper 34 while maintaining the state.

In a state where the corrugated box B is in a substantially horizontal posture while avoiding forward leaning, as the advancing corrugated box B abuts against the flexible stop plate 34a of the front stopper 34, the flexible stop plate 34a absorbs some of kinetic energy of the corrugated box B to decelerate movement of the corrugated box B. Then, after the front end of the corrugated box B abuts against the front stopper 34, the corrugated box B falls while being moved backward by the reaction, and the corrugated box B is held in a substantially horizontal posture to be approximately stacked. The predetermined number of stacks T are stacked to form a batch and the batch is discharged.

As described above, the sheet stacking device according to the second embodiment is provided with the first fan 52 disposed above the downstream side in the hopper unit 21 in the transfer direction of the corrugated box B and pressing the corrugated box B downward with the air AF1, the cam device 101 disposed above the upstream side of the hopper unit 21 in the transfer direction of the corrugated box B and pressing the corrugated box B downward with the cam member 103 which eccentrically rotates by the rotating shaft 102, and the control device controlling the operation of the first fan 52 so as to press the front end of the corrugated box B downward and controlling the operation of the cam device 101 so as to press the rear end of the corrugated box B downward.

Therefore, when the corrugated box B is ejected above the hopper unit 21 by the ejection rolls 22, the eccentrically rotating cam member 103 presses the rear end of the corrugated box B, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state.

### Third Embodiment

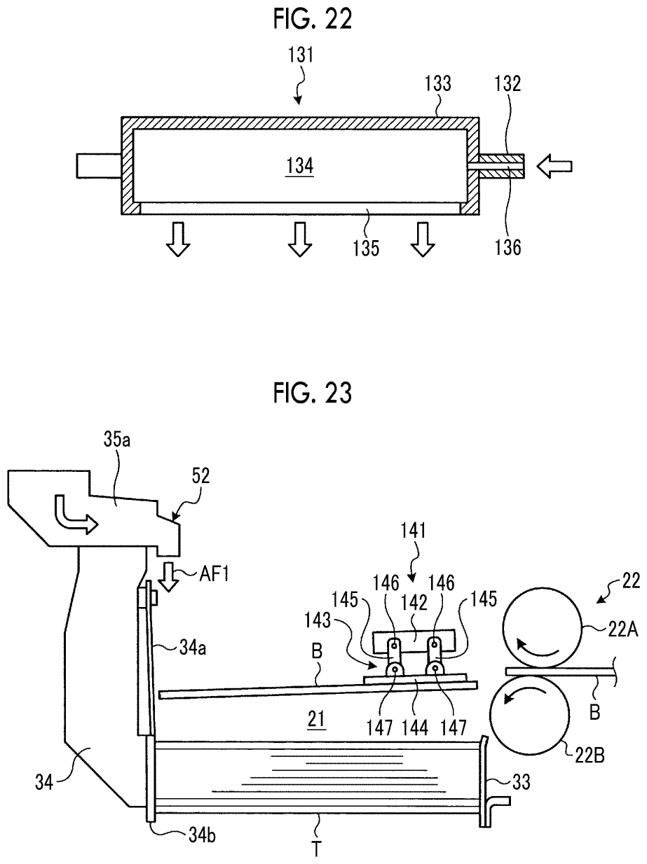

FIG. 21 is a schematic view illustrating a sheet stacking device of a third embodiment. FIG. 22 is a sectional view of a rotary roller. The members having the same functions as those in the above-described embodiment are denoted by the same reference numerals, and detailed descriptions thereof will be omitted.

The sheet stacking device according to the third embodiment, as illustrated in FIG. 21, includes the hopper unit 21, the ejection rolls (ejection unit) 22, the first fan 52, and a second blowing device (pressing device) 131.

As shown in FIGS. 21 and 22, the second blowing device 131 is disposed above the upstream side of the hopper unit 21 in the transfer direction of the corrugated box B and presses the corrugated box B downward using air (blowing). The second blowing device 131 includes a rotating shaft 132, a rotary roller 133, and a drive device (not illustrated). The rotating shaft 132 is disposed along a horizontal direction intersecting the transfer direction of the corrugated box B, each end in an axial direction is rotatably supported by a frame (not illustrated), and the rotating shaft 132 can be rotationally driven by the drive device. The rotary roller 133 is fixed concentrically on the rotating shaft 132. The rotary roller 133 has a cylindrical hollow shape, a hollow portion 134 is formed, and a slit (blowing port) 135 along the axial direction is formed on the outer peripheral portion. The rotating shaft 132 is formed with a flow path 136 for supplying air to the hollow portion 134 from outside.

Therefore, when the rotating shaft 132 is rotated by the drive device, the rotary roller 133 is rotated so that air is blown to the hollow portion 134 through the flow path 136, and blown out from the slit 135. Then, when the corrugated box B is ejected to the upper space of the hopper unit 21 and when the slit 135 of the rotary roller 133 faces the rear end of the corrugated box B, the air blown from the slit 135 presses the rear end of the corrugated box B downward.

As described above, the sheet stacking device according to the third embodiment is provided with the rotary roller 133, as the second blowing device 131, that can rotate about the rotation axis along the horizontal direction intersecting the transfer direction of the corrugated box B, and the slit 135 on an outer peripheral portion of the rotary roller 133 along the rotation axis direction.

Therefore, when the corrugated box B is ejected above the hopper unit 21 by the ejection rolls 22, the slit 135 of the rotary roller 133 faces the rear end of the corrugated box B and air is blown from the slit 135 to the rear end of the corrugated box B, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state.

### Fourth Embodiment

FIG. 23 is a schematic view illustrating a sheet stacking device of the fourth embodiment. The members having the same functions as those in the above-described embodiment are denoted by the same reference numerals, and detailed descriptions thereof will be omitted.

The sheet stacking device according to the fourth embodiment, as illustrated in FIG. 23, includes the hopper unit 21, the ejection rolls (ejection unit) 22, the first fan 52, and a link device (pressing device) 141.

The link device 141 is disposed above the upstream side of the hopper unit 21 in the transfer direction of the corrugated box B and presses the corrugated box B downward using the cam mechanism. The link device 141 includes a supporting member 142, a four-bar link mechanism 143, and a pressing member 144. The supporting member 142 is disposed along the horizontal direction intersecting the transfer direction of the corrugated box B, and the longitudinal ends are fixed to a frame (not illustrated). The four-bar link mechanism 143 has two substantially parallel links 145, one end of each link 145 is rotatably connected to the supporting member 142 by the rotating shaft 146, and the other end thereof is rotatably connected to the pressing member 144 by a mounting shaft 147. The pressing member 144 is disposed along the horizontal direction intersecting the transfer direction of the corrugated box B.

Therefore, in a case where the rotating shaft 146 is rotated by the drive device (not illustrated), the pressing member 144 moves via the four-bar link mechanism 143 (link 145), when the corrugated box B is ejected to the upper space of the hopper unit 21, the pressing member 144 can press the rear end of the corrugated box B downward.

As described above, the sheet stacking device according to the fourth embodiment is provided with the link device 141 disposed above the upstream side of the hopper unit 21 in the transfer direction of the corrugated box B and pressing the corrugated box B downward with a pressing member 144 which is rotated by the four-bar link mechanism 143, and a control device controlling an operation of the first fan 52 so as to press the front end of the corrugated box B downward and an operation of the link device 141 so as to press the rear end of the corrugated box B downward.

Therefore, when the corrugated box B is ejected above the hopper unit 21 by the ejection rolls 22, the rotating pressing member 144 presses the rear end of the corrugated box B, thereby forward downward inclination of the front end of the corrugated box B is inhibited. The corrugated box B can avoid the collision with the corrugated box B stacked on the hopper unit 21 to inhibit damage, and the stacking can be appropriately performed while maintaining the horizontal state.

In the embodiment described above, the first fan 52 as the first blowing device is controlled to be always in operation, but the first fan 52 may be controlled to be in the operating state only when the distal end of the corrugated box B (box making sheet material) moves to the position facing downward.

In the embodiment described above, the second fan 53 as the second blowing device is provided with the three slit-shaped blowing ports 63, 64, and 65, but the number thereof may be one, two, or four or more and many circular openings may be provided regardless of the slit shape.

In the second embodiment described above, the control device (not illustrated) drives and controls the drive device 104, and when the corrugated box B is ejected to the upper space of the hopper unit 21, the rotational speed of the rotating shaft 102 is adjusted to make cam member 103 pressing the rear end of the corrugated box B downward, but the rotational speed of the rotating shaft 102 may be adjusted by a combination of gears.

Additionally, in the above-described embodiment, the box making machine 10 is constituted of the sheet feed section 11, the printing section 12, the slotter creaser section 13, the die cutting section 14, the folder gluer section 15, and the counter ejector section 16. However, in a case where hand holes are unnecessary for the corrugated sheet S, the die cutting section 14 may be eliminated.

1. A sheet stacking device comprising:
a hopper unit on which box making sheet material is stacked;
a ejection unit that ejects the box making sheet material to the hopper unit;
a first blowing device that is disposed above the downstream side of the hopper unit in the transfer direction of the box making sheet material and that presses the box making sheet material downward by blowing air;
a pressing device that is disposed above an upstream side of the hopper unit in the transfer direction of the box making sheet material and that presses the box making sheet material downward; and
a control device that controls an operation of the first blowing device pressing a front end of the box making sheet material downward, and controls an operation of the pressing device so as to press a rear end of the box making sheet material downward with a pressing force higher than that applied to the front end of the box making sheet material.

2. The sheet stacking device according to claim 1,
wherein the control device controls the operation of the pressing device so as to press only the rear end of the box making sheet material downward.

3. The sheet stacking device according to claim 1,
wherein the pressing device is a second blowing device pressing the box making sheet material downward by blowing air.

4. The sheet stacking device according to claim 3,
wherein the control device stops an operation of the second blowing device while the front end of the box making sheet material is transferred below the second blowing device.

5. The sheet stacking device according to claim 4,
wherein the control device stops the operation of the second blowing device while the front end of the box making sheet material enters above the hopper unit.

6. The sheet stacking device according to claim 5,
wherein the control device starts the operation of the second blowing device after the rear end of the box making sheet material passes the ejection unit.

7. The sheet stacking device according to claim 4,
wherein a position sensor detecting a transfer position of the box making sheet material is provided, and
wherein the control device controls the operation of the second blowing device based on a detecting result of the position sensor.

8. The sheet stacking device according to claim 3,
wherein the control device sets a pressing force of the second blowing device against the box making sheet material higher than a pressing force of the first blowing device against the box making sheet material.

9. The sheet stacking device according to claim 3,
wherein the second blowing device includes a plurality of blowing ports which are aligned along the transfer direction of the box making sheet material and a plurality of damper mechanisms which open and close the plurality of blowing ports, and
wherein the control device sequentially opens the plurality of damper mechanisms from the upstream side in the transfer direction of the box making sheet material.

10. The sheet stacking device according to claim 3,
wherein the second blowing device includes a rotary roller capable of rotating about a rotation axis along a horizontal direction intersecting the transfer direction of the box making sheet material, and a blowing port disposed on an outer peripheral portion of the rotary roller along a rotation axis direction.

11. The sheet stacking device according to claim 1,
wherein the pressing device is a cam device including a cam member capable of rotating about a rotation axis along a horizontal direction intersecting the transfer direction of the box making sheet material.

12. A counter ejector comprising:
the sheet stacking device according to claim 1,
wherein the box making sheet materials are sorted in a batch of a predetermined number of sheets and are discharged after being stacked while being counted.

13. A box making machine comprising:
a sheet feed section feeding a box making sheet material;
a printing section that performs printing on the box making sheet material;
a slotter creaser section that performs creasing on a front surface of the box making sheet material and performs grooving;
a folder gluer section that folds the box making sheet material to join ends together, thereby forming a box member; and
a counter ejector section that discharges every predetermined number of the box members after being stacked while counting the number of the box members,
wherein the counter ejector according to claim 12 is applied as the counter ejector section.

14. The sheet stacking device according to claim 5,
wherein a position sensor detecting a transfer position of the box making sheet material is provided, and
wherein the control device controls the operation of the second blowing device based on a detecting result of the position sensor.

15. The sheet stacking device according to claim 6,
wherein a position sensor detecting a transfer position of the box making sheet material is provided, and
wherein the control device controls the operation of the second blowing device based on a detecting result of the position sensor.
